(19) United States
(12) Patent Application Publication
(10) Pub. No.: US 2012/0175492 A1
(43) Pub. Date: Jul. 12, 2012

(54) Cake mold

(76) Inventor: Katherine A. Guiliani, Beresfield (AU)

(21) Appl. No.: 13/374,722

(22) Filed: Jan. 10, 2012

(30) Foreign Application Priority Data
Jan. 12, 2011 (AU) 2011900071

(51) Int. Cl. B29C 33/42

(52) U.S. Cl. 249/140

(57) ABSTRACT

A disposable cake mold for making numbered cakes, particularly birthday cakes or anniversary cakes. The cake mold is constructed from one piece of material with a bottom plate containing a pressed out number. The bottom plate is integrally connected to a wall which is prefably disposed perpendicular to the bottom plate.

### CROSS-REFERENCES TO RELATED APPLICATIONS

This application claims the benefit of Australian Provisional Patent Application No. 2011900071, filed Jan. 12, 2011, the disclosure of which patent application is incorporated by reference as if fully set forth herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

This invention relates to a cake mold that is suitable for baking cakes. In particular, the invention relates to a cake mold comprising at least one numbered bottom plate and a wall positioned perpendicular to the numbered bottom plate.

Cake molds are usually known as having a mostly round, square, flat or scalloped shape base or bottom plate. Whereas the present invention aims at providing a cake mold which need not necessarily have a round shape or square shape, yet can have various shapes and more particularly has a pressed out number shape within the bottom plate. Although cake molds with a base plate and a wall perpendicular to the bottom base plate and numbered cake molds are already known, they do not involve a bottom plate wherein is a pressed number with a bottom plate and the wall made of one piece which can be used to easily and economically produce cakes, particularly birthday or anniversary cakes. Accordingly, there is a need in the art for a user-friendly, inexpensive and disposable cake mold which can be easily used to produce numbered cakes.

The background art is characterized by U.S. Pat. No. 3,107,587; the disclosure of which patent is incorporated by reference as if fully set forth herein. The background art is also characterized by the cake molds disclosed at WWW Doman: cooksdream.com/store/bkn.html.

### BRIEF SUMMARY OF THE INVENTION

It is an object of illustrative embodiments of the present invention to substantially overcome or at least ameliorate one or more of the above disadvantages, or at least to provide a useful alternative. Objects of illustrative embodiments of the present invention are (without limitation): to provide a cake mold which can be used to easily produce numbered birthday cakes or anniversary cakes; to provide a user friendly and disposable cake mold; and to provide a cake mold which is cheap and disposable. Such advantages will become apparent with the following description and drawings.

As used herein, the following terms and variations thereof have the meanings given below, unless a different meaning is clearly intended by the context in which such term is used:

“A,” “an” and “the” and similar referents used herein are to be construed to cover both the singular and the plural unless their usage in context indicates otherwise.

“About” means within ten percent of a recited parameter or measurement, and preferably within five percent of such parameter or measurement.

“Basically perpendicular” means within five degrees of being perpendicular.

“Comprise” and variations of the term, such as “comprising” and “comprises,” are not intended to exclude other additives, components, integers or steps.

“Exemplary,” “illustrative,” and “preferred” mean “another.”

Illustrative embodiments of the invention are characterized in that the wall is flexible and integral to the bottom plate. The bottom plate contains at least one pressed out number which acts as a further mold within the entire cake mold. The wall is flexible and integral to the bottom base plate. After using the cake mold, the mold is inverted to allow the cake to cool and to pull off the cake thereby producing a cake comprising of a number on the top of the cake corresponding to the relevant birthday age or anniversary.

Advantageously, in illustrative embodiments, the cake mold is to be made of a durable and malleable material such as aluminum, as this material allows the wall and bottom plate to be flexible and disposable. The disclosed aluminum cake mold is also relatively inexpensive to produce.

In another embodiment, advantageously, the aluminum is covered with an anti-adhesive or non-stick agent, e.g., Teflon®. As a result, the wall and the bottom plate can be detached easily from the cake after using them, without requiring the cake mold to be greased before usage.

In a first aspect, an illustrative embodiment of the present invention provides a disposable aluminum cake mold comprising a bottom plate comprising a pressed out number shape, the bottom plate being integrally connected with the wall.

In an illustrative embodiment, the invention is a cake mold comprising: a top end; a wall that is connected to said top end; a bottom plate that is connected to said top end by said wall; and a character in said base plate, said character having a side wall; wherein said top end, said wall, said bottom plate and said character are pressed into a single sheet of aluminum; wherein said wall and said side wall are disposed at an offset angle relative to a direction that is perpendicular to said top end; wherein said character is a digit; and wherein said top end is rectangular in shape with rounded corners.

In another illustrative embodiment, the invention is a cake mold comprising: a top end that is disposed in a first plane; a wall that is connected to said top end; a bottom plate that is connected to said top end by said wall, at least a portion of said bottom plate being disposed in a second plane that is parallel to said first plane; and a pressed out number in said base plate, said pressed out number having a side wall. In another embodiment, said top end, said wall, said bottom plate and said pressed out number are pressed into a single sheet of a malleable metal. In another embodiment, said wall and said side wall are disposed at an offset angle relative to a direction that is perpendicular to said first plane. In another embodiment, said top end is rectangular in shape with rounded corners. In another embodiment, at least the interior of said cake mold is covered with an anti-adhesive agent.

In yet another illustrative embodiment, the invention is a disposable cake mold comprising: a single sheet of aluminum into which a top end, a wall, a bottom plate comprising a pressed out number having a side wall have been pressed; thereby rendering said top end, said wall, said bottom plate comprising a pressed out number having a side wall integrally connected. In another embodiment, at least the interior of said disposable cake mold is treated with a non-stick agent. In another embodiment, said wall and said bottom plate are flexible. In another embodiment, said disposable cake mold is square or circular in plan.

In a further illustrative embodiment, the invention is a cake mold kit comprising: more than one of the cake molds disclosed herein; wherein said digit on each cake mold is a different digit. In another embodiment, said different digits are 0, 1, 2, 3, 4, 5, 6 or 9, 7, and 8.

In yet another illustrative embodiment, the invention is a cake mold kit comprising: a plurality of the cake molds disclosed herein; wherein said pressed out number on each cake mold is a different pressed out number. In another embodiment, said different pressed out numbers are 0, 1, 2, 3, 4, 5, 6 or 9, 7, and 8.

Further aspects of the invention will become apparent from consideration of the drawings and the ensuing description of exemplary embodiments of the invention. A person skilled in the art will realize that other embodiments of the invention are possible and that the details of the invention can be modified in a number of respects, all without departing from the concept. Thus, the following drawings and description are to be regarded as illustrative in nature and not restrictive.

### BRIEF DESCRIPTION OF THE SEVERAL VIEWS OF THE DRAWINGS

The features of the invention will be better understood by reference to the accompanying drawings which illustrate exemplary embodiments of the invention. In the drawings:

FIG. 1 is a top (plan) view of the number 0 cake mold in its inverted position, that is, with the base plate facing up;

FIG. 1A is a side (elevation) view of the cake mold shown in FIG. 1;

FIG. 1B is a perspective view of the cake mold in its inverted position;

FIG. 1C is a perspective view of the cake mold in the position in which it would be filled with cake mix;

FIG. 2 is a top view if the number 1 cake mold in its inverted position, that is, with the base plate facing up;

FIG. 2A is a perspective view of the number 1 cake mold in the position in which it would be filled with cake mix;

FIG. 3 is a top view of the number 2 cake mold in its inverted position;

FIG. 3A is a side view of the cake mold shown in FIG. 3;

FIG. 3B is a perspective view of the cake mold shown in FIG. 3 in its inverted position;

FIG. 3C is a perspective view of the cake mold in the position in which it would be filled with cake mix;

FIG. 4 is a top view of a numbered cake mold in its inverted position;

FIG. 4A is a side view of the cake mold shown in FIG. 4;

FIG. 4B is a perspective view of the cake mold in its inverted position;

FIG. 4C is a perspective view of the cake mold in the position in which it would be filled with cake mix;

FIG. 5 is a top view of a numbered cake mold in its inverted position;

FIG. 5A is a side view of the cake mold shown in FIG. 5;

FIG. 5B is a perspective view of the cake mold in its inverted position;

FIG. 5C is a perspective view of the cake mold in the position in which it would be filled with cake mix;

FIG. 6 is a top view of a numbered cake mold in its inverted position;

FIG. 6A is a side view of the cake mold shown in FIG. 6;

FIG. 6B is a perspective view of the cake mold in its inverted position;

FIG. 6C is a perspective view of the cake mold in the position in which it would be filled with cake mix;

FIG. 7 is a top view of a numbered cake mold in its inverted position;

FIG. 7A is a side view of the cake mold shown in FIG. 7;

FIG. 7B is a perspective view of the cake mold in its inverted position;

FIG. 7C is a perspective view of the cake mold in the position in which it would be filled with cake mix;

FIG. 8 is a top view of a numbered cake mold in its inverted position;

FIG. 8A is a side view of the cake mold shown in FIG. 8;

FIG. 8B is a perspective view of the cake mold in its inverted position;

FIG. 8C is a perspective view of the cake mold in the position in which it would be filled with cake mix;

FIG. 9 is a top view of a numbered cake mold in its inverted position;

FIG. 9A is a side view of the cake mold shown in FIG. 9;

FIG. 9B is a perspective view of the cake mold in its inverted position;

FIG. 9C is a perspective view of the cake mold in the position in which it would be filled with cake mix.

The drawings are purely schematic and not drawn to scale. Particularly for purposes of clarity, some dimensions have been represented in a greatly exaggerated manner.

The following reference numerals are used to indicate the parts and environment of an illustrative embodiment of the invention on the drawings:

10 cake mold

12 bottom plate

14 wall

16 pressed out number

18 top end

20 side wall

### DETAILED DESCRIPTION OF THE INVENTION

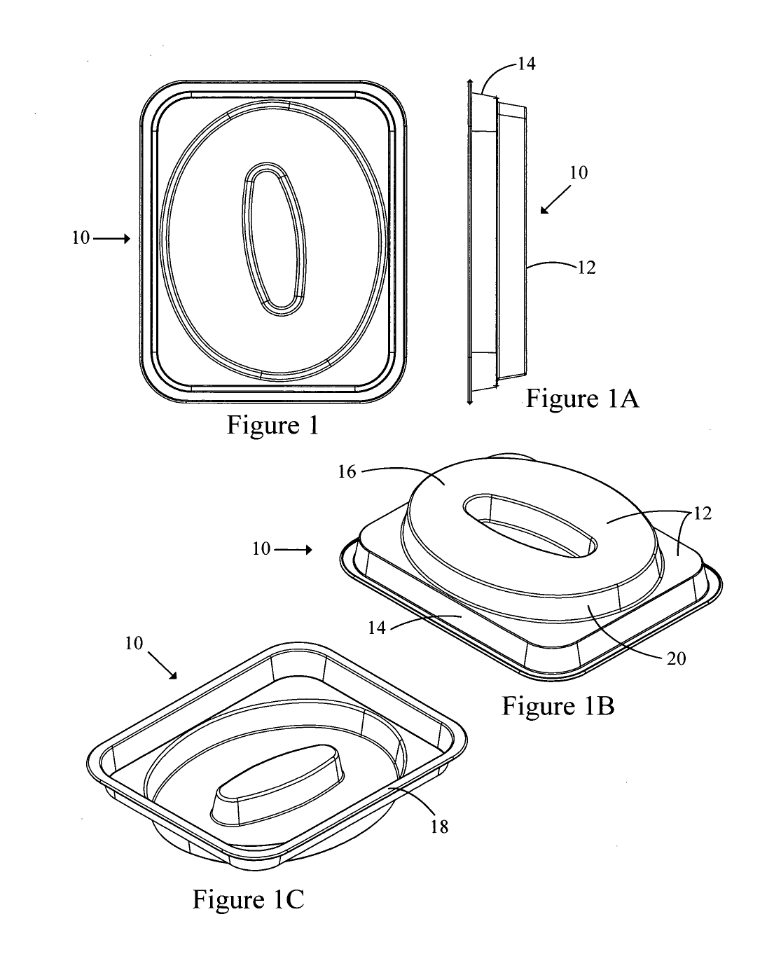

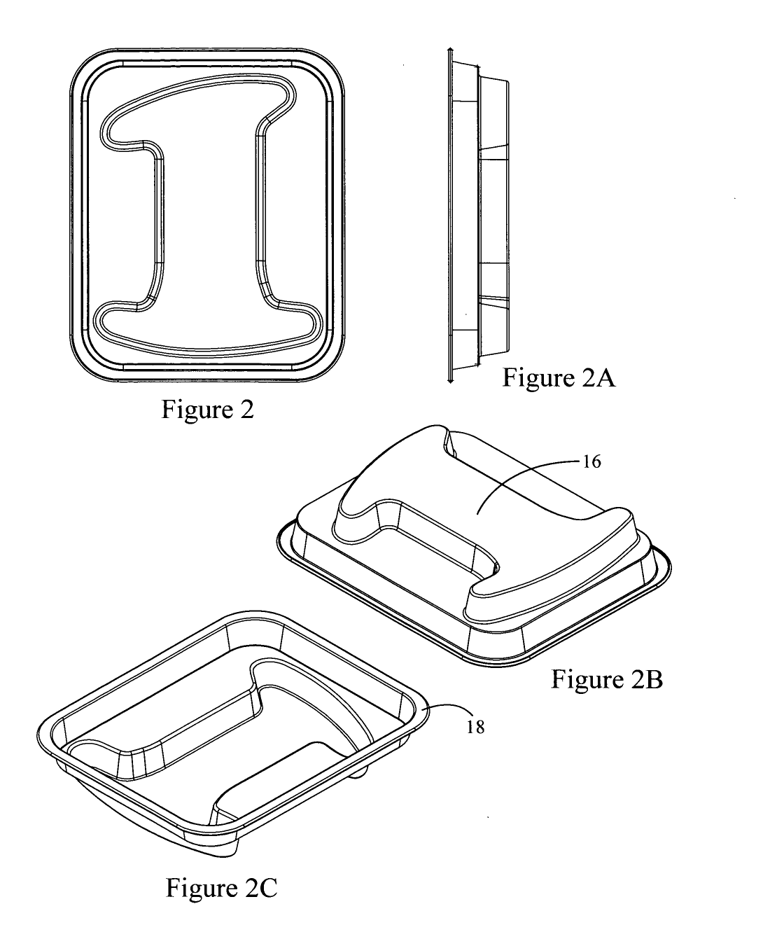

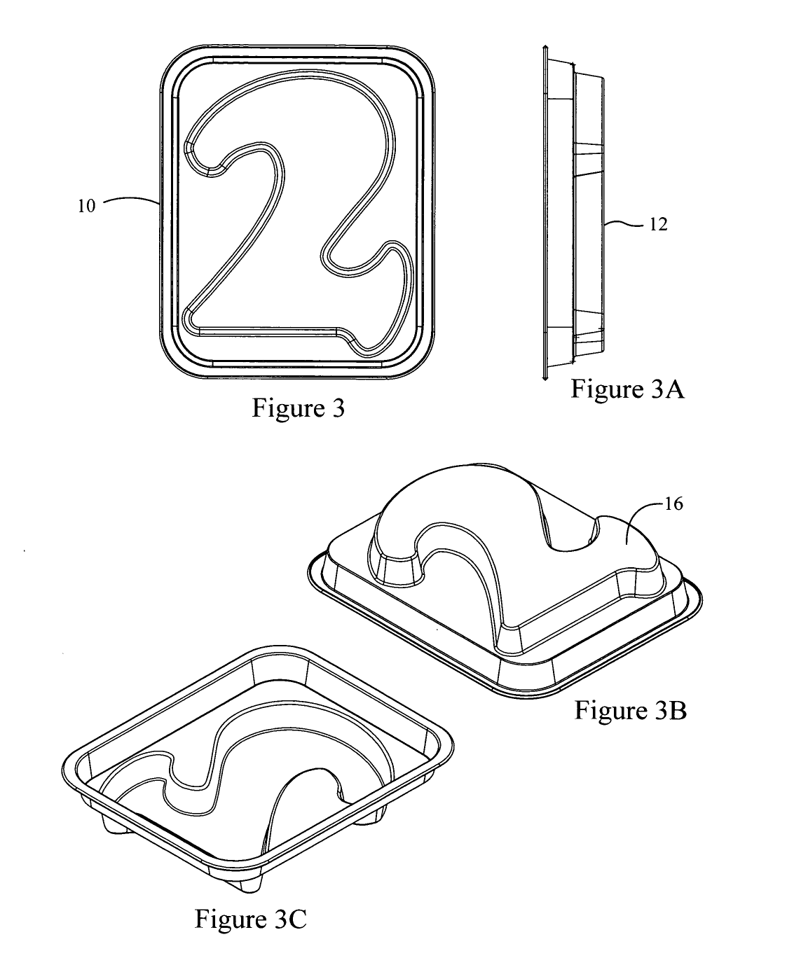

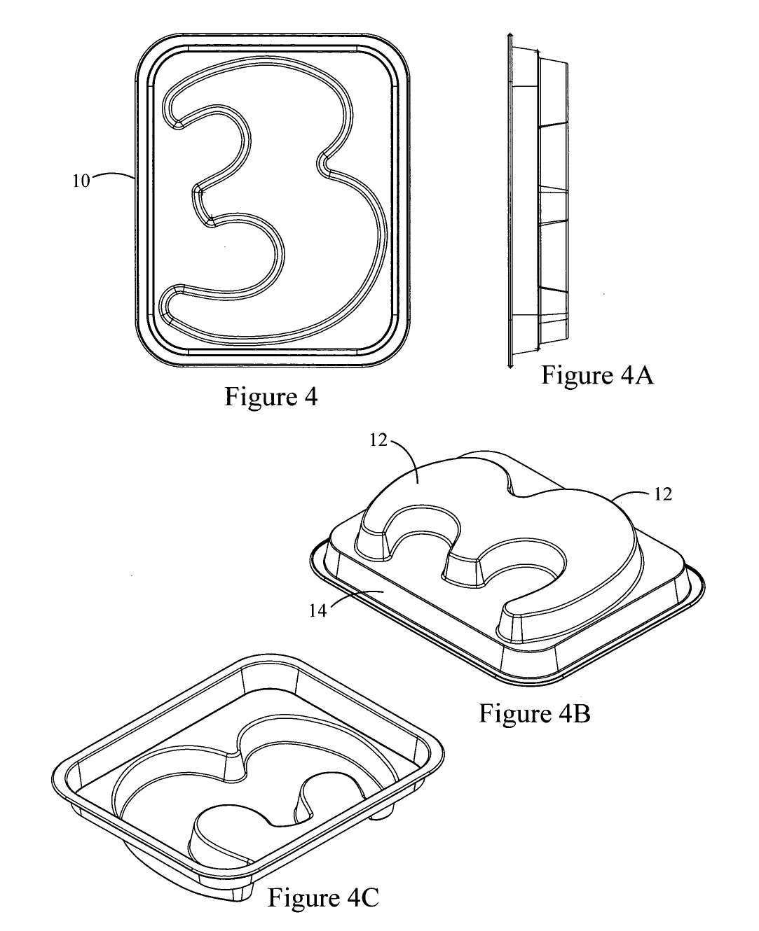

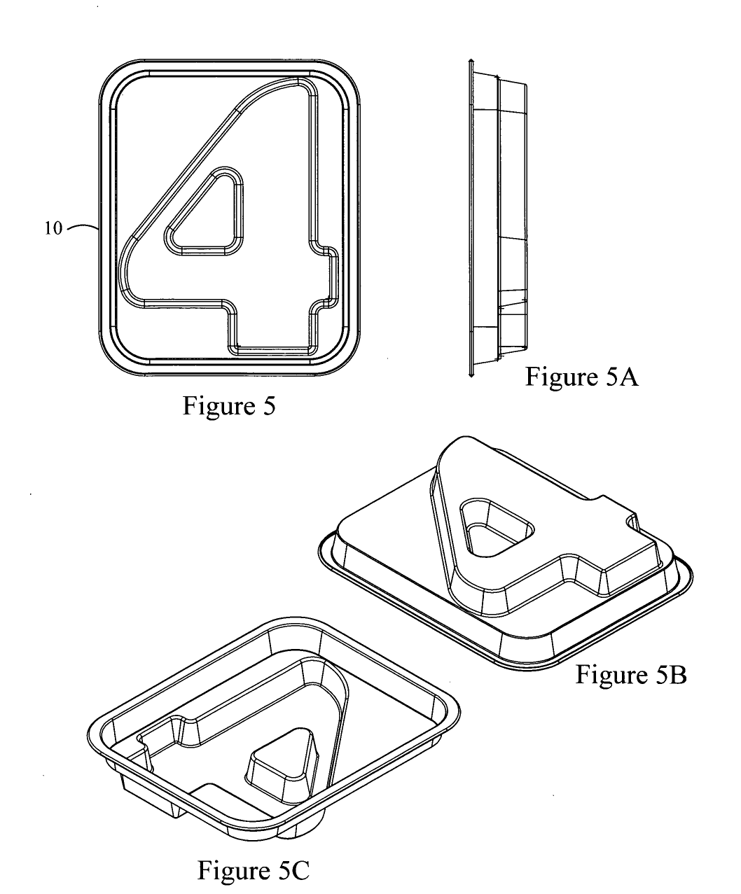

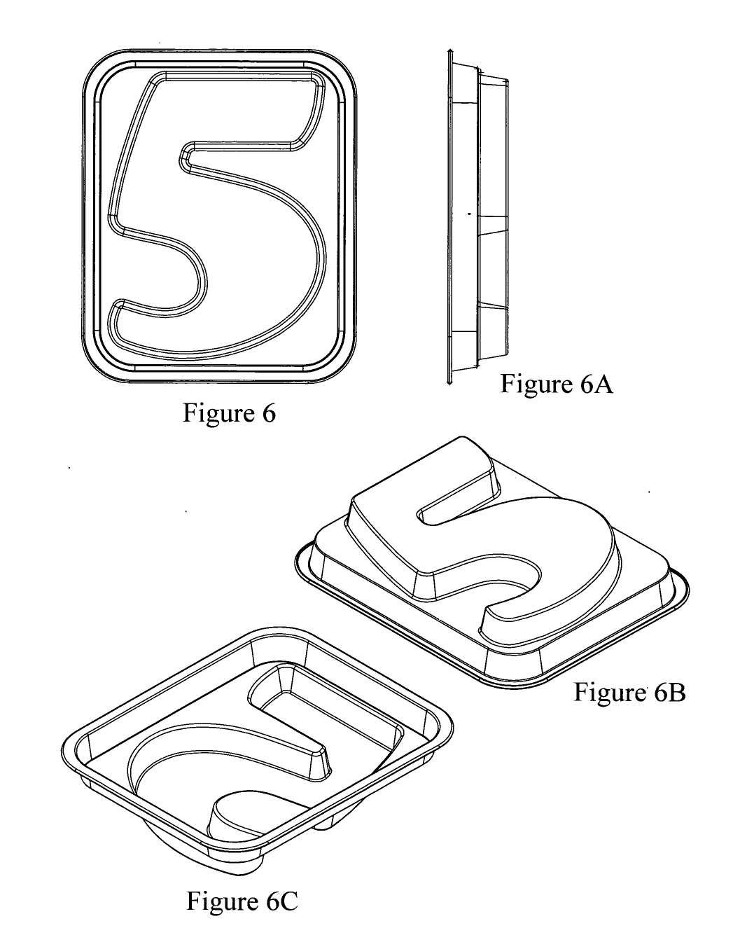

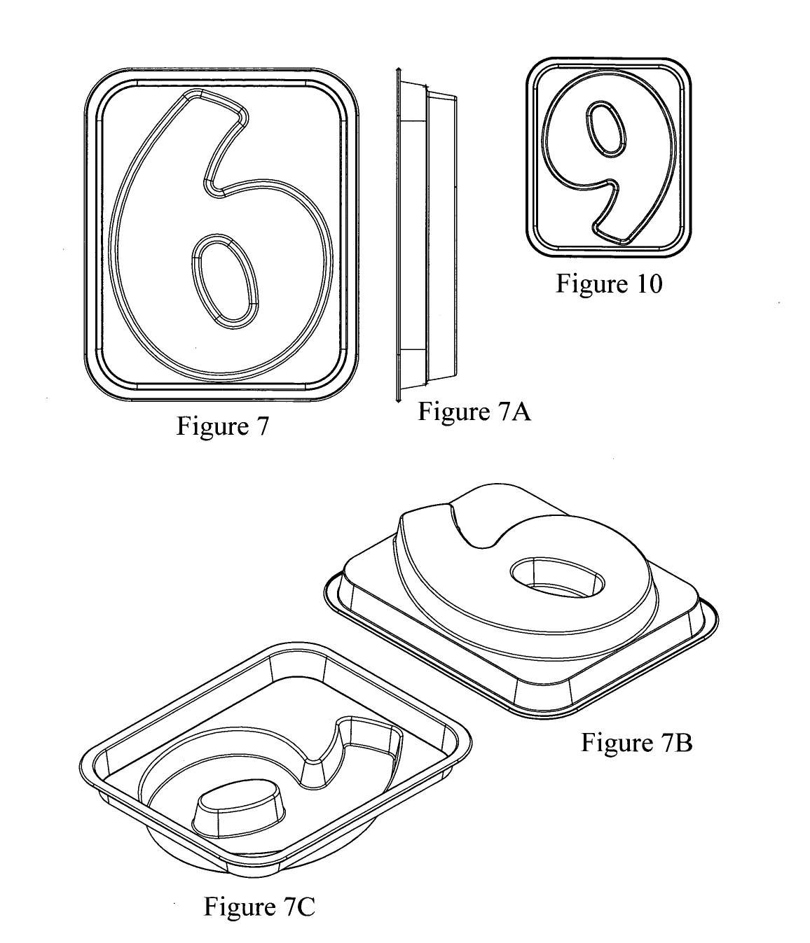

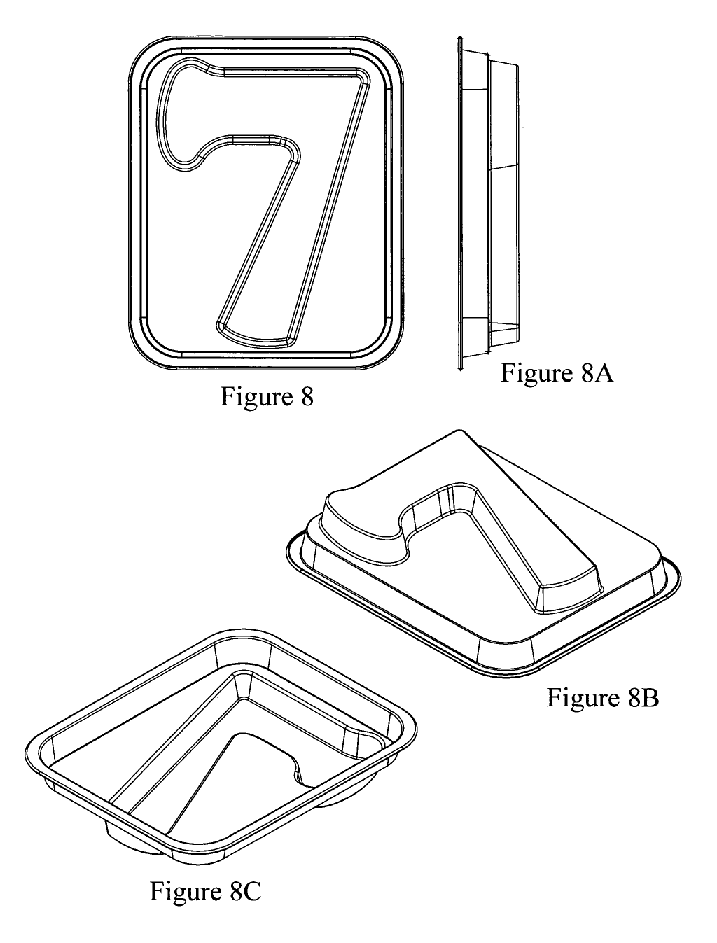

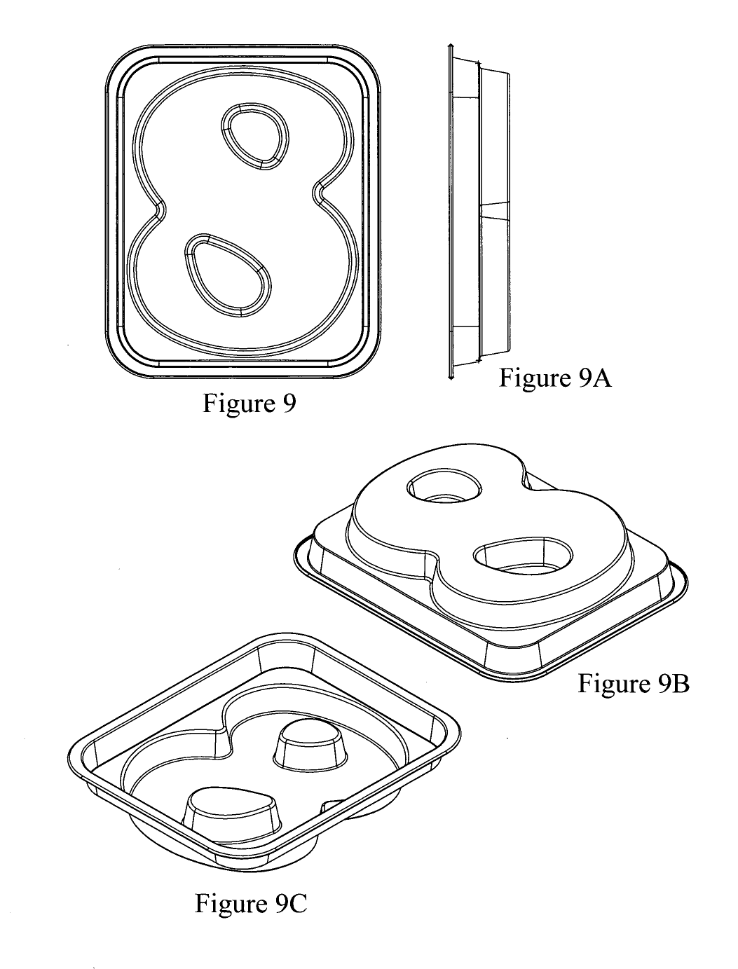

FIGS. 1, 2, 3, 4, 5, 6, 7, 8, 9, and 10 present an illustrative embodiment of cake mold 10 according to the present invention, which comprises bottom plate 12 with wall 14 preferably extending basically perpendicular to bottom plate 12. Wall 14 is preferably made of flexible material as is bottom plate 12. Bottom plate 12 contains a pressed out number 16 on its surface. An illustrative embodiment of the invention will now be described by way of an illustrative example with reference to the accompanying drawings.

In another illustrative embodiment, cake mold 10 is provided with a draft or taper. A person having ordinary skill in the art would know that a draft or taper is the offset angle in a direction that is parallel to the direction of cake removal from cake mold 10.

An illustrative embodiment of cake mold 10 is shown in the accompanying drawings. Referring to FIGS. 1C, 2C, 3C, 4C, 5C, 6C, 7C, 8C, and 9C, cake mold 10 is depicted from top end 18 to base plate 12 of cake mold 10. Cake mold 10 comprises base plate 12 and wall 14. Base plate 20 comprises therein a pressed out number 16. Base plate 12 is also integrally connected to wall 14 and wall 14 is integrally connected to top end 18.

In the embodiment as shown in FIGS. 1, 2, 3, 4, 5, 6, 7, 8 and 9, top end 18 of cake mold 10 is generally rectangular in shape with rounded corners. However, it will be appreciated that cake mold 10 may be made in other suitable shapes, e.g., square or circular. Accordingly, although the invention has been described with reference to specific examples, it will be appreciated by those skilled in the art that the invention may be embodied in many other forms. It should therefore be understood that modifications to the present invention may be made without departing from the scope of the invention.

Operation of an illustrative embodiment of the invention involves pouring cake mix (not shown) into cake mold 10, baking the cake, and removing the cake from cake mold 10.

Many variations of the invention will occur to those skilled in the art. Some variations include pressed digits. Other variations call for pressed letters. All such variations are intended to be within the scope and spirit of the invention.

Although some embodiments are shown to include certain features or steps, the applicant specifically contemplates that any feature or step disclosed herein may be used together or in combination with any other feature or step on any embodiment of the invention. It is also contemplated that any feature or step may be specifically excluded from any embodiment of the invention.

What is claimed is:

1. A cake mold comprising:
a top end;
a wall that is connected to said top end;
a bottom plate that is connected to said top end by said wall; and
a character in said base plate, said character having a side wall;
wherein said top end, said wall, said bottom plate and said character are pressed into a single sheet of aluminum;
wherein said wall and said side wall are disposed at an offset angle relative to a direction that is perpendicular to said top end;
wherein said character is a digit; and
wherein said top end is rectangular in shape with rounded corners.

2. A cake mold comprising:
a top end that is disposed in a first plane;
a wall that is connected to said top end;
a bottom plate that is connected to said top end by said wall, at least a portion of said bottom plate being disposed in a second plane that is parallel to said first plane; and
a pressed out number in said base plate, said pressed out number having a side wall;
wherein said top end, said wall, said bottom plate and said pressed out number are pressed into a single sheet of a malleable metal.

3. The cake mold of claim 2 wherein said wall and said side wall are disposed at an offset angle relative to a direction that is perpendicular to said first plane.

4. The cake mold of claim 2 wherein said top end is rectangular in shape with rounded corners.

5. The cake mold of claim 2 wherein at least the interior of said cake mold is covered with an anti-adhesive agent.

6. A disposable cake mold comprising:
a single sheet of aluminum into which a top end, a wall, a bottom plate comprising a pressed out number having a side wall have been pressed;
thereby rendering said top end, said wall, said bottom plate comprising a pressed out number having a side wall integrally connected.

7. The disposable cake mold of claim 6 wherein at least the interior of said disposable cake mold is treated with a non-stick agent.

8. The disposable cake mold of claim 6 wherein said wall and said bottom plate are flexible.

9. The disposable cake mold of claim 6 wherein said disposable cake mold is square or circular in plan.

10. A cake mold kit comprising:
more than one of the cake molds of claim 1;
wherein said digit on each cake mold is a different digit.

11. The cake mold kit of claim 10 wherein said different digits are 0, 1, 2, 3, 4, 5, 6 or 9, 7, and 8.

12. A cake mold kit comprising:
a plurality of the cake molds of claim 2;
wherein said pressed out number on each cake mold is a different pressed out number.

13. The cake mold kit of claim 12 wherein said different pressed out numbers are 0, 1, 2, 3, 4, 5, 6 or 9, 7, and 8.
